(19) United States
(12) Patent Application Publication
(10) Pub. No.: US 2005/0178614 A1
(43) Pub. Date: Aug. 18, 2005

(54) Interchangeable lanyard attachment with intergrated gripper

(76) Inventors: Robert N. Brosofsky, Tewksbury, MA (US); Lee Porter, Keene, NH (US)

Correspondence Address: BANNER & WITCOFF, LTD., 28 STATE STREET, 28th FLOOR, BOSTON, MA, 02109-9601, US

(21) Appl. No.: 11/055,408

(22) Filed: Feb. 10, 2005

Related U.S. Application Data
(60) Provisional application No. 60/545,073, filed on Feb. 17, 2004.

(51) Int. Cl. A62B 1/16

(52) U.S. Cl. 182/5

(57) ABSTRACT

Disclosed is a molded plastic device, adapted for use as an interchangeable lanyard attachment with integrated gripper, comprising a main body with means for gripping two ends of lanyard material, and a ball joint member for mounting a separate attachment device to the main body. Preferably this device is constructed of molded plastic elements that snap together to form a structure that can easily be assembled, and easily customized by virtue of optional attachment devices.

### PRIORITY CLAIM

This application claims priority from copending U.S. Provisional Patent Application Ser. No. 60/545,073, filed 17 Feb. 2004, the disclosure of which is hereby incorporated herein by reference.

### BACKGROUND OF THE INVENTION

Lanyards and gripping devices for lanyards and lanyard-like straps are well known. See for example U.S. Patent Publication No. 2003-0121125, as well as the devices shown in U.S. Pat. Nos. 6,044,527; 5,842,256; 5,689,860; 5,608,918; 5,572,771; 5,533,238; 1,763,100; and 3,881; the disclosures of which are hereby incorporated herein by reference.

### SUMMARY OF THE INVENTION

The present invention includes a unique “combination” of two attachment principles. First, the device of the invention utilizes the “gripper” technology of U.S. Patent Publication No. 2003-0121125, the disclosure of which is incorporated herein by reference. The gripper means comprise a plurality of teeth, which act to lock the lanyard material to the unit. Second, the device further includes a ball and socket (or ball joint) connecting means, which is used to mount other attachment devices to the lanyard gripper unit.

Preferably, the teeth used to lock sections of lanyard material into the gripper unit are provided in the main body of the device. However, gripping teeth could likewise be provided in other parts of the unit, for example the hinged doors discussed below. This could be in addition to, or in lieu of, the teeth provided in the main body of the device.

Preferably, the ball joint means comprises a hole located on the vertical distal end of the gripper unit, which accepts a variety of attachment devices, each provided with a round stud or ball member (male attachment) used to fasten the attachment device into the socket hole. This is a well known type of mechanical connection used between two parts that permits motion in nearly all directions that the ball can rotate in the socket.

As the name implies, the ball joint consists essentially of a spherical knob (or “ball”) at the end of a shaft, with the knob fitting securely into a mating socket. In the present invention, the use of the ball and socket combination (the ball part preferably being on the attachment device, and the socket part preferably being on the lanyard gripper unit) allows the user to easily change attachment devices on the gripper unit as desired. The user simply removes one attachment device, e.g., by separating the joined ball part from the socket part, and inserts the ball part of another device into the same socket.

Thus, the present invention is directed to a molded plastic device, adapted for use as an interchangeable lanyard attachment with integrated gripper, comprising a main body with means for gripping two ends of lanyard material, and a ball joint member for mounting a separate attachment device to the main body.

Preferably, the main body of the device further comprises two hinged doors as part of the means for gripping two ends of lanyard material. In addition, the device preferably further comprises a plurality of teeth as part of the means for gripping two ends of lanyard material. Advantageously, the teeth are located in the main body of the device.

Preferably, the outside surface of the main body is provided with one or more substantially flat surfaces. Such surfaces are ideal locations for the placement of one or more displays, for example advertising. In the preferred embodiment, the main body has a generally “V” shaped body.

As described above, the device includes a ball joint member for mounting separate attachment devices to the main body. Preferably, one part of the ball joint member comprises a socket located in the distal end of the main body of the device. When a separate attachment device is to be mounted to the main body, it advantageously has a complementary part of the ball joint member, namely the ball part, located on the proximal end (i.e., the end nearest the main body in use). Advantageously, the ball part further comprises a neck portion which extends from the ball member toward the distal end of the separate attachment device, and which terminates in a collar portion. To assist the placement of the ball in the socket of the ball joint member, the ball may include one or more slits therein, allowing the ball to be compressed during passage into the socket hole. Any of the known attachment devices may be used with this device, following the adaptation thereof to a ball joint attachment mechanism. This may include the use of an intermediate adaptor member with the ball joint member at one end thereof and the separate attachment device at the other end. Examples of such attachment devices include a swivel snap hook device; a swivel bull-dog clip device; a swivel split ring device; and a metal or plastic swivel hook device.

As for the lanyard material to be gripped by the main body—any common material used in the construction of neck lanyards is suitable for use in the present invention. Lanyard materials can be thin or thick, woven or non-woven, natural materials (cotton, silk, rayon, and the like) or synthetic materials (plastics, nylon, Dacron, and the like). The shapes and sizes of lanyard materials are usually dictated by the desired use of the lanyard. Those that are designed for temporary use are made of materials and with dimensions that are not designed to last a long time. Those that are designed for permanent use are made of materials and with dimensions that should last a long time. If desired, a break-away section can be included in the lanyard material—as a safety device.

Another embodiment of this invention is a kit containing various lanyard materials and attachment devices are another embodiment of this invention, permitting the creation of custom lanyard designs at trade shows, conventions, schools, places of employment and the like. The gripper unit is the common piece for such customized products.

Assembly of a custom designed lanyard is a simple process of (a) selecting the desired lanyard material (precut to conventional length), (b) selecting the desired attachment device; and (c) mounting the selected parts (a) and (b) to the gripper unit. The addition of press-on displays is also available in kit form.

### BRIEF DESCRIPTION OF THE DRAWINGS

FIG. 1 shows an exploded view of the preferred four part (1A, 1B, 1C, 1D) embodiment of the present invention, namely an interchangeable lanyard attachment with integrated gripper.

FIG. 2 shows a plan view of the top of the preferred embodiment of the present invention, with the elements of FIGS. 1A, 1B and IC mounted onto the element of FIG. 1D.

FIG. 3 shows a close up view of the top (or interior) of the preferred embodiment of the present invention, showing more detail thereof than FIG. 1D.

FIG. 4 shows a plan view of the bottom of the preferred embodiment of the present invention, namely the bottom side of FIG. 1D.

FIG. 5, consisting of parts 5A and 5B, is a drawing showing the preferred angles and dimensions for the preferred embodiment of the element labeled as 1C in FIG. 1.

FIG. 6, including FIGS. 6A, 6B, 6C and 6D, is a drawing showing the preferred angles and dimensions for the preferred embodiment of the element labeled as ID in FIG. 1.

FIG. 7, is a drawing showing one version of the invention, with a lanyard mounted in place at one end of the device, and with a card mounted to a snap hook at the other end of the device.

FIGS. 7A, 7B, 7C, and 7D illustrate various preferred attachment devices which may be used with the gripper unit of the present invention.

FIG. 8 shows one preferred ball configuration (shown at the top of an enlarged snap hook) for use with the gripper unit of the present invention.

### DETAILED DESCRIPTION OF THE INVENTION

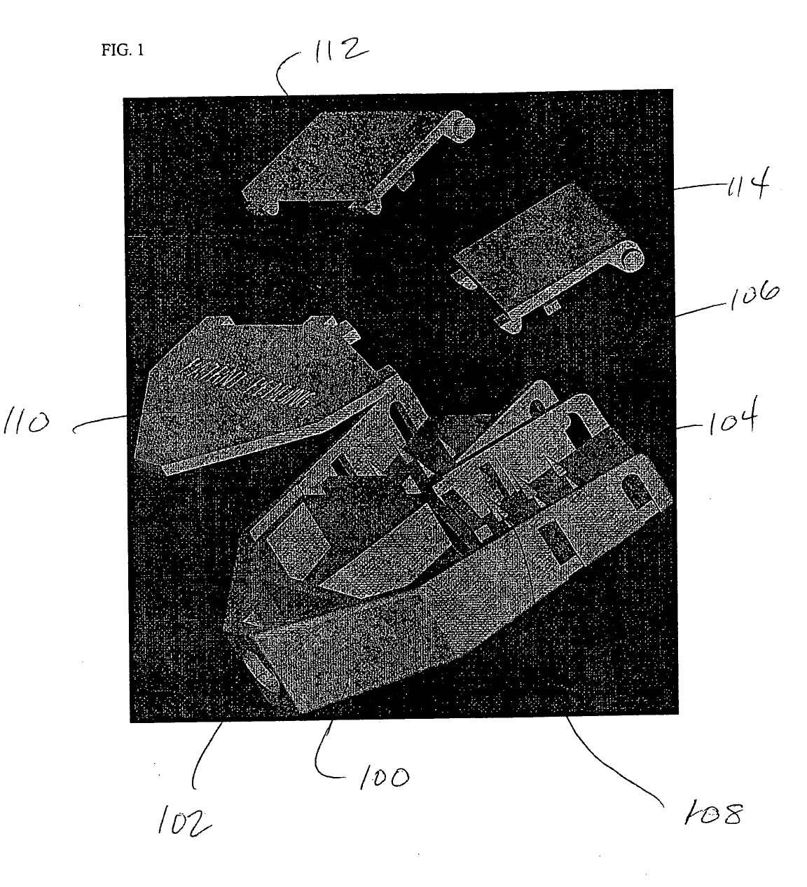

As shown in the drawings accompanying this specification, the present invention comprises an interchangeable lanyard attachment with integrated gripper. As shown in FIG. 1, this device is basically constructed of molded plastic consisting of four main elements 100, 110, 112 and 114, that snap together to form a complete device for holding the ends of a lanyard. If desired, this number of individual parts could be reduced to two elements (the main body 100) and, for example, a combination unit comprising the two hinged doors 112 and 114 and the surface element 110, e.g., through the use of living hinges.

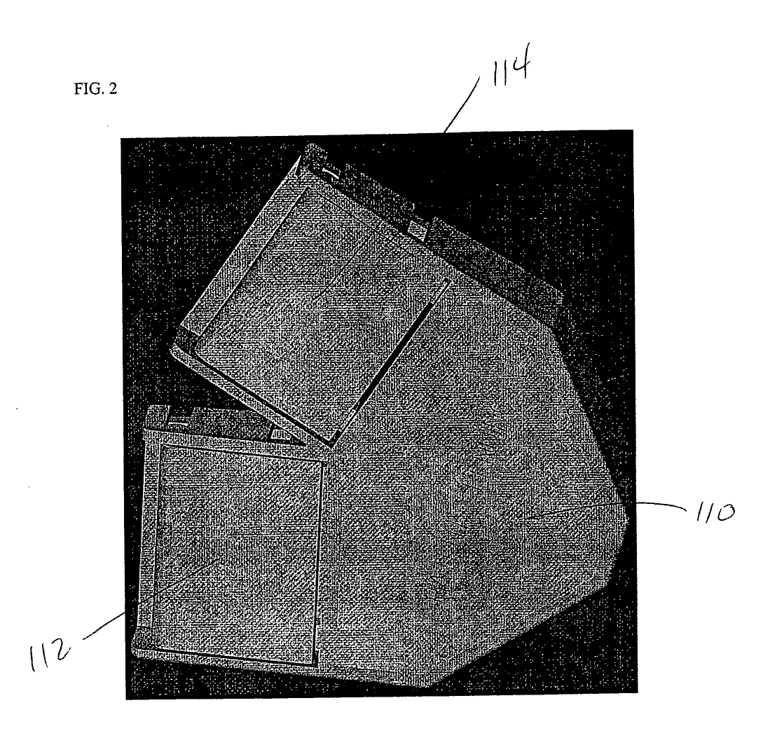

As shown in FIGS. 2, 3, 4, 5 and 6, the preferred assembled configuration resembles a large “V” with the angle of the V being approximately 30 degrees. This is an angle that has been optimized for the connection of both ends of a neck lanyard, thus making the unit comfortable for hanging around the user's neck. This angle also serves to maintain the hanging elements in the desired location on the wearer's body, avoiding the twisting problem often encountered with conventional style lanyard assemblies.

As shown in FIG. 2, when closed, the surface element 110 and the gripper doors 112 and 114 provide a flat surface—ideal for displays, such as advertisements or the like. The parts are designed to snap-lock and, as shown in FIG. 1, each door is provided with two hinges (only one shown) to permit easy opening and closing.

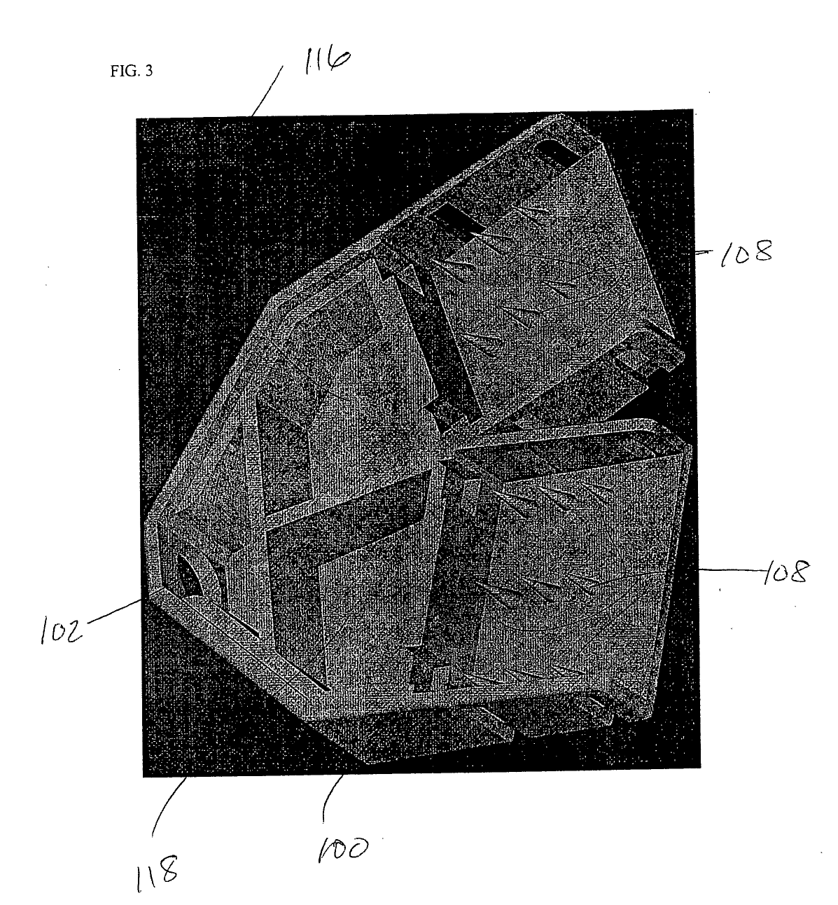

FIG. 3 illustrates the interior construction of the preferred gripper unit 100. The body is molded plastic, with a mounting hole 102 at one end and internal compartments 116 and 118 provided for strength. The lanyard gripper sections 104 and 106 are provided with a number of teeth 108 which grip the lanyard material once the doors (not shown) are closed. In the illustrated embodiment, three rows of three teeth (each), for a total of nine teeth in each gripper section, are provided. This number of teeth is not critical, but in this embodiment is preferred. Each gripper section could have more or fewer teeth and still perform adequately, depending upon the nature of the lanyard material being gripped therein. Likewise, which the shape of the teeth 108 shown in the illustrated embodiment is akin to a sharp spike, this is also not critical, as the shape of the teeth need only be adequate to secure the lanyard material inside the gripper section.

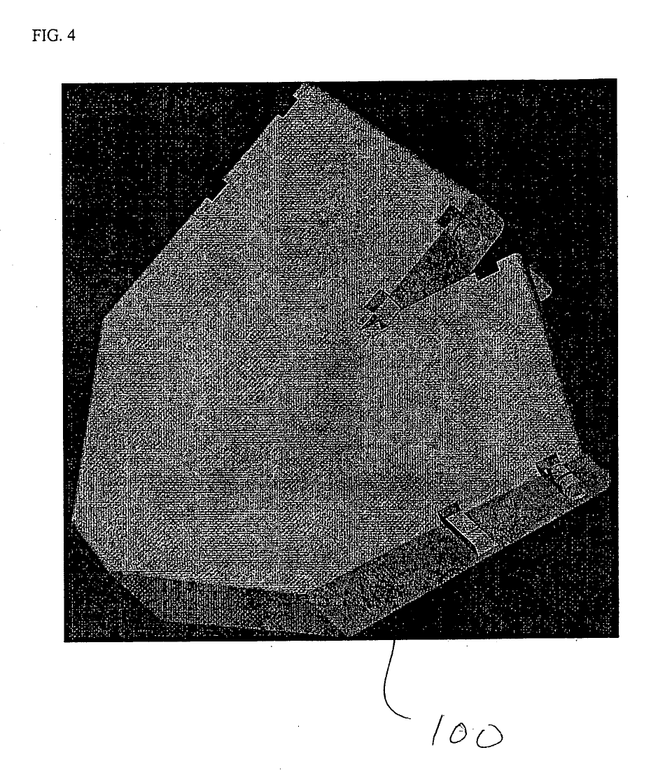

FIG. 4 shows the side of the gripper unit 100 which does not include the gripper doors. This side is ideal for printing—as there are no breaks in the surface.

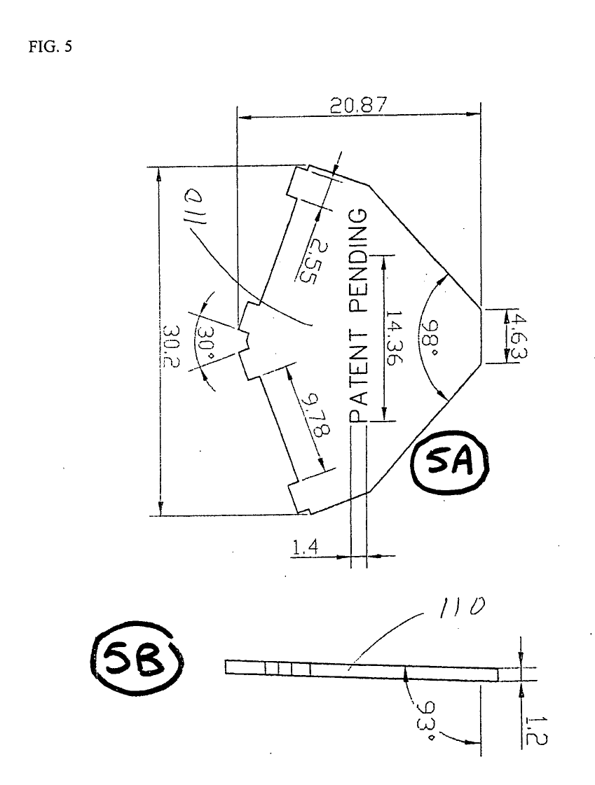

FIG. 5, which includes views 5A and 5B, illustrates the preferred dimensions (in mm) of the surface element 110. As best shown in FIG. 5B, this element is thin and angled.

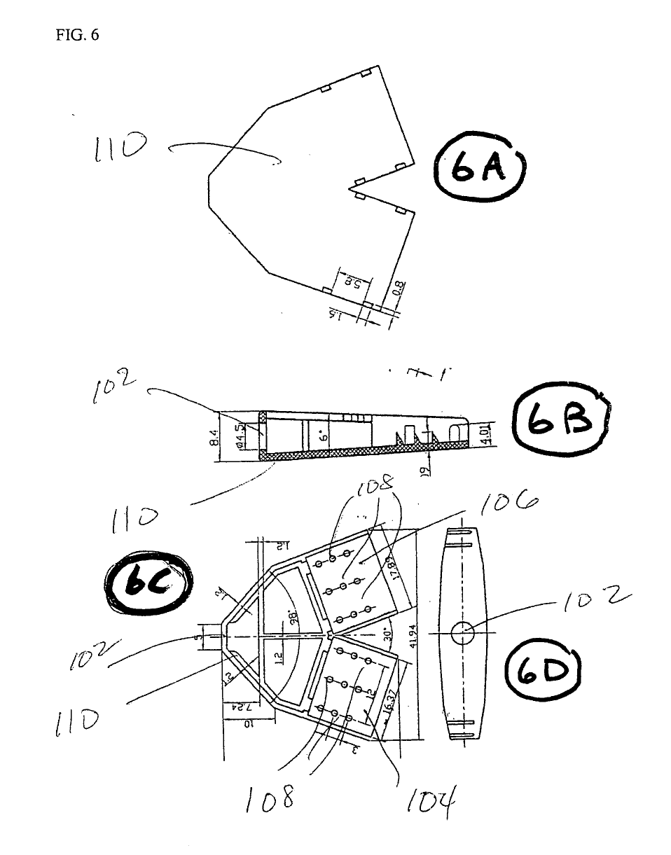

FIG. 6, which consists of views 6A, 6B, 6C and 6D, illustrates the preferred dimensions (in mm) of the gripper unit 110.

FIG. 6A is a plan view of the flat surface. FIG. 6B shows a cross-sectional view of the interior of the unit. The mounting socket 102 is shown on the left and three teeth 108 are shown on the right. The angled nature of the body is also shown.

FIG. 6C is a plan view of the interior of the preferred gripper unit 110. The teeth 108 are shown in the lanyard gripper sections 104 and 106, and the attachment mounting socket (not shown) is at location 102. FIG. 6D illustrates an end view of the gripper unit from the mounting hole 102.

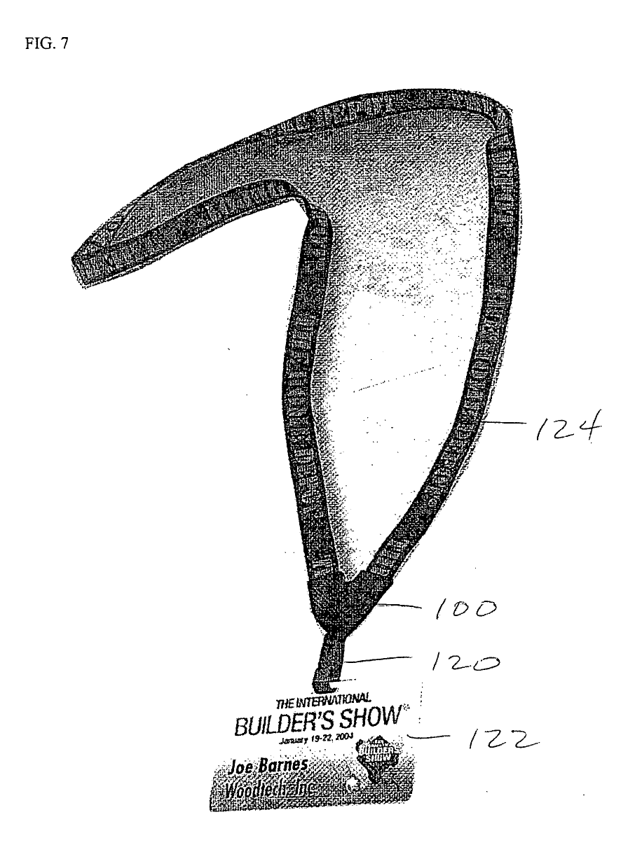

FIG. 7 shows one complete version of the invention 100, with a lanyard 124 mounted in the gripper unit mounting slots 108, together with an attachment device 120, which in this case is a plastic swivel snap hook mounted (via the ball joint mechanism—not visible) mounted in the hole 102 at the distal end of the device, with an ID badge 122 (or conference badge, or the like) mounted thereto.

FIG. 7A also shows a plastic swivel snap hook style clip 120 mounted to the gripper unit 100—mounted via a ball joint mechanism (not visible).

FIG. 7B shows a bull-dog style clip 134 mounted to the gripper unit 100—mounted via a ball joint mechanism (not visible).

FIG. 7C shows a split ring style clip 136 mounted to the gripper unit 100—mounted via a ball joint mechanism (not visible).

FIG. 7D shows a metal swivel hook style clip 138 mounted to the gripper unit 100—mounted via a ball joint mechanism (not visible).

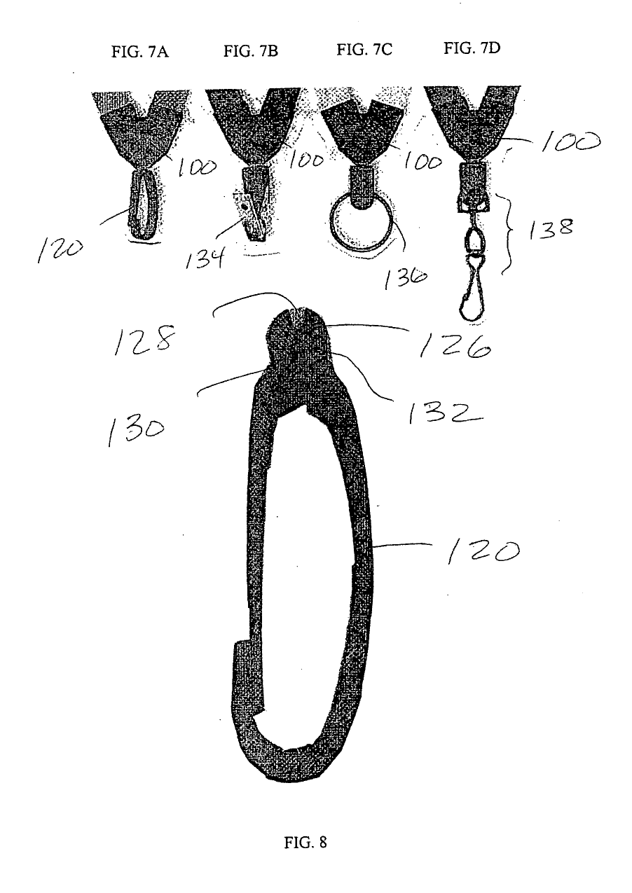

FIG. 8 shows one preferred ball configuration 126 used in the ball joint attachment mechanism of the present invention. The ball 126 includes an optional longitudinal slit 128 in the center, which permits the compression of the ball when being forced into the mounting hole 102 of the gripper unit. Once the ball 126 passes through the hole—the resilient nature of the plastic material causes the ball to expand back to its original dimension, which keeps the ball in the hole. A straight neck portion 132 extends slightly below the ball 126 and a collar portion 130 is provided below the neck to provide stability to the snap hook as it freely rotates in the hole 102.

Not only does the above concept offer a novel arrangement of attachment techniques, it also offers significant improvement in efficiency of assembly procedures in that it lends itself easily to allow displays, such as custom printing on the flat surfaces, short run assembly runs, as well as volume activity runs, permitting the use of combinations of colors, and different style attachments. Additionally, the large flat surface also allows for displays such as custom logos or printing if desired. Displays of logos having the size and shape of the “V” of the gripper unit can readily be made as press-on labels. Orders place in advance could be screen printed or otherwise provided with desired advertising, school colors and/or logos, and the like.

Kits containing various lanyard materials and attachment devices are another embodiment of this invention, permitting the creation of custom lanyard designs at trade shows, conventions, schools, places of employment and the like. The gripper unit 100 is the common piece for such customized products. Assembly of a custom designed lanyard is a simple process of (a) selecting the desired lanyard material (precut to conventional length), (b) selecting the desired attachment device; and (c) mounting the selected parts (a) and (b) to the gripper unit 100. The addition of press-on displays is also available in kit form.

1. A molded plastic device, adapted for use as an interchangeable lanyard attachment with integrated gripper, comprising a main body with means for gripping two ends of lanyard material, and a ball joint member for mounting a separate attachment device to the main body.

2. The device of claim 1, wherein the main body further comprises two hinged doors as part of the means for gripping two ends of lanyard material.

3. The device of claim 2, wherein the device further comprises a plurality of teeth as part of the means for gripping two ends of lanyard material.

4. The device of claim 3, wherein the teeth are located in the main body of the device.

5. The device of claim 1, wherein one or more substantially flat surfaces are provided on the main body outer surface.

6. The device of claim 5, further comprising a display on at least one of the flat surfaces.

7. The device of claim 1, wherein the main body has a “V” shape.

8. The device of claim 1, wherein one portion of the ball joint member comprises a socket located in the distal end of the main body of the device.

9. The device of claim 1, further comprising a separate attachment device adapted for mounting to the main body.

10. The device of claim 9, wherein the separate attachment device further comprises a ball member located on the proximal end thereof.

11. The device of claim 10, wherein the ball member further includes a neck portion which extends from the ball member toward the distal end of the separate attachment device.

12. The device of claim 11, wherein the ball member further includes a collar portion located distal to the neck portion of the separate attachment device.

13. The device of claim 10, wherein the ball member further comprises a slit therein.

15. The device of claim 10, wherein the separate attachment device comprises a swivel snap hook device.

16. The device of claim 10, wherein the separate attachment device comprises a swivel bull-dog clip device.

17. The device of claim 10, wherein the separate attachment device comprises a swivel split ring device.

18. The device of claim 10, wherein the separate attachment device comprises a swivel hook device.

19. The device of claim 1, further comprising gripped lanyard material selected from the group consisting of woven cloth, non-woven cloth, synthetic materials, natural materials, flat material, round material, wide straps, and thin straps.

20. The device of claim 19, wherein the lanyard material further comprises a break-away section.

21. A custom designed lanyard kit comprising:
a variety of lanyard materials;
a variety of separate attachment devices, each provided with a ball joint member complementary to the ball joint member of a molded plastic device, adapted for use as an interchangeable lanyard attachment with integrated gripper;
the molded plastic device comprising a main body with means for gripping two ends of the lanyard material.

22. The custom designed lanyard kit of claim 21, further comprising press-on displays for mounting on the main body.

23. A method of forming custom designed lanyards comprising the steps of:
(a) selecting a desired lanyard material;
(b) selecting a desired ball joint attachment device; and
(c) mounting the selected parts (a) and (b) to a molded plastic device comprising a main body with means for gripping two ends of the lanyard material and a complementary ball joint member for mounting the separate attachment device to the main body.
